(19) United States
(12) Patent Application Publication
(10) Pub. No.: US 2010/0151413 A1
(43) Pub. Date: Jun. 17, 2010

(54) DENTAL POLISHING DEVICE

(76) Inventors: Göran Andersson, Nynashamn (SE); Joakim Ahlman, Nynashamn (SE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/531,674

(22) PCT Filed: Mar. 6, 2008
(86) PCT No.: PCT/SE2008/050252

§ 371 Date: Feb. 26, 2010

Related U.S. Application Data
(60) Provisional application No. 60/895,161, filed on Mar. 16, 2007.

(30) Foreign Application Priority Data
Mar. 16, 2007 (SE) 0700677-8

(51) Int. Cl. A61C 3/025

(52) U.S. Cl. 433/88

(57) ABSTRACT

To provide a dental instrument that can be connected to existing operational units, such as dental units and table-top devices, in order to allow dental polishing procedures, an embodiment of the present invention is directed to a dental polishing device (1) comprising a powder chamber (2) for holding abrasive powder. The powder chamber (2) comprises an inlet (5) and an outlet (6) arranged to be brought in fluid communication with an operational unit (11) for controlling a supply of pressurized air through the powder chamber (2) to a hand-held instrument (3) connectable to the outlet (6) of the powder chamber (2) through a hose (4). The dental polishing device (1) comprises a connection mechanism and is arranged to be fixedly but detachably connected external to the operational unit (11) through the connection mechanism.

### TECHNICAL FIELD

The present invention relates to a dental polishing device according to the preamble of claim 1, and a dental polishing apparatus according to the preamble of claim 14.

### BACKGROUND OF THE INVENTION

Dental polishing apparatuses are used to remove plaque, soft calculus, stains and discolourations from the teeth of dental patients. They are also used to polish and clean tooth surfaces. The polishing treatment is performed by directing pressurized gas, most often air, containing abrasive polishing powder towards the treatment area where the powder particles effectively removes discolorations and stains. Normally, a fine jet of pressurized water surrounding the flow of gas and powder mixture is also directed towards the treatment area to avoid powder dust and removed particles to spread inside the patient's oral cavity.

A typical polishing apparatus comprises a hand-held polishing instrument which is connected via a hose to an operational unit. The operational unit comprises all components necessary for attaining overall operation of the polishing apparatus, that is, all means necessary for providing a pressurized stream of air containing polishing powder, and a pressurized stream of water, to the handheld instrument. Normally, this includes a powder chamber containing the abrasive polishing powder arranged in fluid communication with the stream of pressurized air, a control circuitry typically comprising different conduits, valves, pressure regulators and filters for controlling the flow of fluids through the operational unit, and an operator input device for regulating the flow of gas and/or water provided to the handheld instrument.

The abrasive powder used in dental polishing procedures is a fine granular powder which, during refill procedures and normal operation of the polishing device, tends to leak out of the powder chamber and form undesired powder dust which, in worst case, damages the operational unit. Furthermore, the fine-grained powder easily forms lumps when exposed to moisture which, due to the inevitable humidity in the pressurized air, causes clogging in the powder chamber and all downstream components of the polishing device. Therefore, frequent cleaning of the polisher apparatus components is necessary. However, the operational unit including the integrated powder chamber and all the fluid circuitry components are not easily cleaned and, therefore, trained service technicians must be sent for to handle the maintenance of the operational unit. The need for continuous maintenance of the operational unit is costly and, of course, hampers and delays the exercise of the dentist profession.

To avoid the above problems, several providers of dental polishing apparatuses have proposed the solution of moving the powder chamber normally disposed within the operational unit to form a part of the hand-held polisher instrument. One example of such a polisher device is the Easyjet Pro from Mectron® medical technology which could be seen on Internet, http://www.mectron.com/easyjet_pro/Eeasyjet_pro.html, 2007-03-16. However, positioning the powder chamber at the hand-held instrument increases the weight and size thereof, preventing a precise, effective and comfortable operation of the instrument. These effects can be minimized by making the powder chamber very small but then the duration of use becomes very short for the polisher apparatus, requiring a frequent refilling of the powder chamber.

Another state-of-the-art polisher apparatus is Air Max air-polisher from Satelec®, which could be seen on Internet, http://www.acteongroup.com/SiteSatMax/lang_u/produits.asp?pge=airmax, 2007-03-16. This product is a table-top polisher wherein the powder chamber is externally mounted to facilitate replenishment thereof.

As indicated above, there are basically two different types of polishing apparatuses available in the dental market; integrated polishing apparatuses in which the operational unit is integrated in the dental unit (the dental chair and the standard devices connected thereto or integrated therein), or stand-alone polishing apparatuses, often referred to as table-top apparatuses. Integrated polishing apparatuses are seldom popular among dental unit manufactures since they require modification of the dental unit design and functionality. Table-top apparatuses do not require any modification of the dental unit design or functionality and are normally connected to the same pressurized air and water source as the dental unit. However, table-top apparatuses are bulky and need to be located at a convenient distance from both the dental professional and the patient, that is, in the immediate surroundings of the dental unit. This space in a dentist surgery is often occupied by other dental equipment and instruments, and by the dentist himself and often a dental hygienist or assistant. Therefore, to save space in the dental surgery, many dental professionals still prefer the polishing apparatuses integrated in the dental unit.

### SUMMARY OF THE INVENTION

It is an object of the present invention to provide a dental instrument that can be connected to existing operational units in order to allow dental polishing procedures.

The object is achieved by dental polishing device comprising a powder chamber for holding abrasive powder, said powder chamber comprising an inlet and an outlet arranged in fluid communication with an operational unit for controlling a supply of pressurized air through the powder chamber to a hand-held instrument connected to the outlet of the powder chamber through a hose. The dental polishing device is characterized in that it comprises connection means and is arranged to be fixedly but detachably connected external to the operational unit through said connection means.

By connecting the new kind of polishing device to existing operational units, such as a dental unit or a stand-alone table-top device, arranged to control a supply of pressurized air to different dental instruments, a polishing apparatus can be provided without the need for adjusting or replacing the existing dental unit, or buying a separate table-top polishing device, thus saving space and money for dental surgeries.

Another advantage of the polishing device according to the present invention is that the powder chamber is connected external to the operational unit, preventing leakage of powder particles into the operational unit and its components. Thus, no clogging will appear inside any table-top device or dental unit to which the polishing device is connected, eliminating the need for time-consuming and expensive cleaning and maintenance thereof.

Yet another advantage of the polishing device according to the invention is that the powder chamber is separated from a hand-held dental instrument connected thereto. Thereby, the weight and the bulkiness of the powder chamber do not have a negative effect on the polishing procedure performed by the dental professional handling the hand-held dental instrument. The ergonomic design of the polishing device allows a precise, effective and comfortable operation of a hand-held polishing instrument.

Preferably, the powder chamber comprises means for providing both pressurized air and pressurized water, supplied by the operational unit, to a hand-held dental instrument connected to the outlet of the powder chamber through a hose. This can be achieved by providing the powder chamber with two separate fluid channels, one for receiving a flow of pressurized air and one for receiving a flow of pressurized water from the operational unit, in which case the air channel inside the powder chamber is arranged in fluid communication with the abrasive powder comprised therein, while the water channel is not. The powder chamber may comprise a single inlet for receiving both water and air, or, preferably, two separate inlets for receiving water and air, respectively.

Preferably, the powder chamber also comprises means for receiving electric signals from the operational unit and for providing the electric signals to a hand-held dental instrument connected to the outlet of the powder chamber through a hose. Thereby, a hand-held polishing instrument can be provided with light to increase visibility during polishing procedures.

Preferably, the connection means of powder chamber is connected directly to a connector of the operational unit. Thereby, the need for intermediate hoses or conduits is eliminated, minimizing the size and number of components of the polishing apparatus.

Preferably, the at least one inlet of the powder chamber is arranged to constitute the connection means of the powder chamber. By providing at least one inlet of the powder chamber with connection means, they can be arranged to serve the double purpose of receiving the air, water, and electric signals from the operational unit, as well as providing for the fixed but yet detachable connection thereto. Thereby, the size and number of components of the polishing device is minimized, and the operational unit to which the polishing device is connected does not have to be modified. This may be achieved by arranging at least one inlet of the powder chamber to constitute a female connector, adapted to receive a male connector protruding from the operational unit and providing the air, water, and electric signals there from. Of course, the opposite is also possible, i.e. to provide the inlet of the powder chamber with a male connector, adapted to be connectable to an outlet of the operational unit in form of a female connector.

### BRIEF DESCRIPTION OF THE FIGURES

FIG. 1 illustrates a first embodiment of the dental polisher device according to the present invention.

FIG. 2 illustrates a second embodiment of the dental polisher device according to the present invention.

FIG. 3 illustrates a third embodiment of the dental polisher device according to the present invention.

FIG. 4 shows a schematic block diagram of a typical operational unit known in the art, such as a dental unit or a stand-alone table-top device.

FIG. 5 shows an exploded view of the dental polishing device according to the present invention.

FIG. 6 illustrates the dental polishing device according to the present invention connected to an operational unit in form of a table-top device.

FIG. 7a shows a cross section of the powder chamber and the connection means for establishing a connection between the powder chamber and the operational unit, taken along the line I-I, according to one embodiment of the present invention.

FIG. 7b shows another cross section of the powder chamber and the connection means illustrated in FIG. 7a, taken along the line II-II.

FIG. 7c shows the connection means of the operational unit, connected to the powder chamber in FIG. 7a-7b.

### DETAILED DESCRIPTION OF THE INVENTION

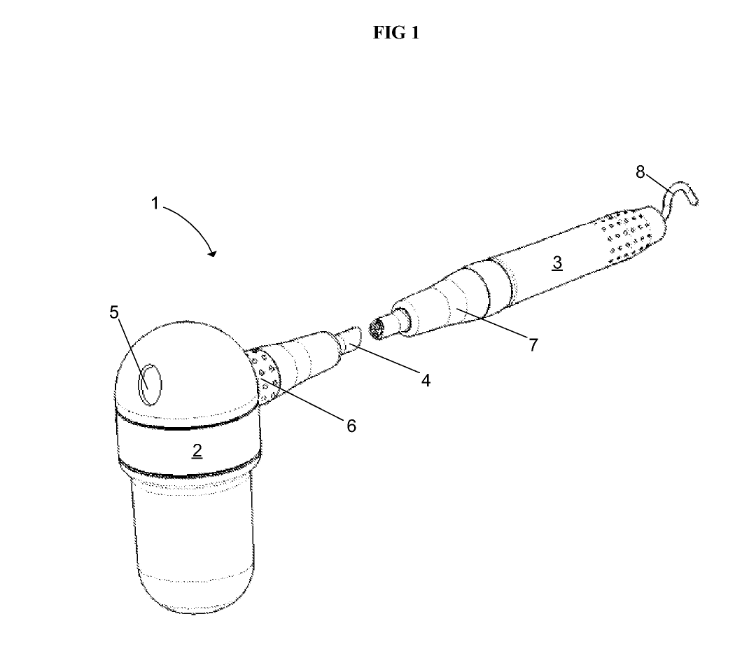

FIG. 1 shows a dental polisher device 1 according to one embodiment of the present invention. A powder chamber 2 is connected to a hand-held polisher instrument 3 via a hose 4. The powder chamber 2 comprises an inlet 5 for connecting the powder chamber 2 to a pressurized air source (not shown), and an outlet 6 to which the hose 4 is connected. The hand-held polisher instrument 3 is detachably connected to the hose by means of handpiece connector 7, enabling a dental professional to use the hand-held polisher instrument 3 of his choice.

During operation, a flow of pressurized air passes the powder chamber 2 and absorbs some of the abrasive polishing powder contained therein, continues via the hose 4 to the hand-held polisher instrument 3, and is directed towards a treatment area by means of a nozzle 8, detachably connected to the front portion of the hand-held instrument 3.

Typically, the flow of air creates a “whirlwind” inside the powder chamber 2 making the fine-grained powder particles mix with the air to form a polishing flow which is provided to the handpiece 3. However, there are many other ways of adding a suitable amount of powder particles to the pressurized air flow inside the powder chamber 2 and a person skilled in the art appreciates that the present invention is not limited to any particular way of doing so.

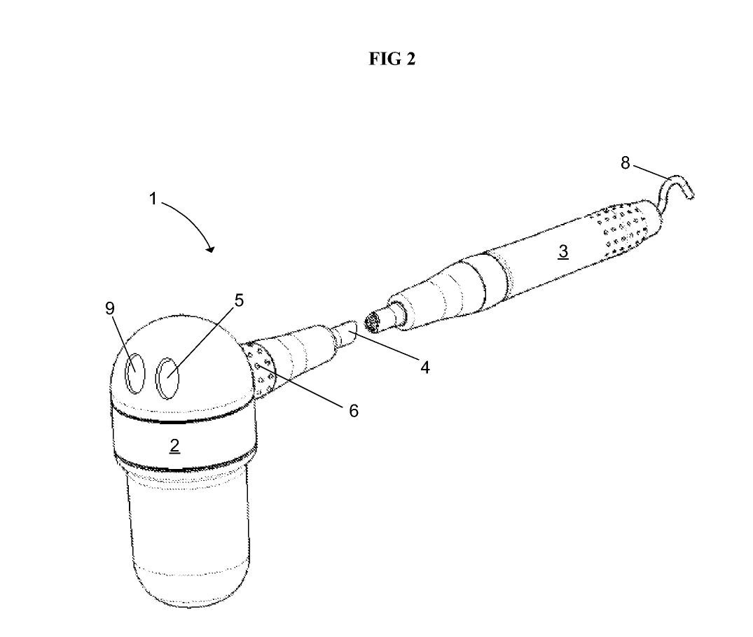

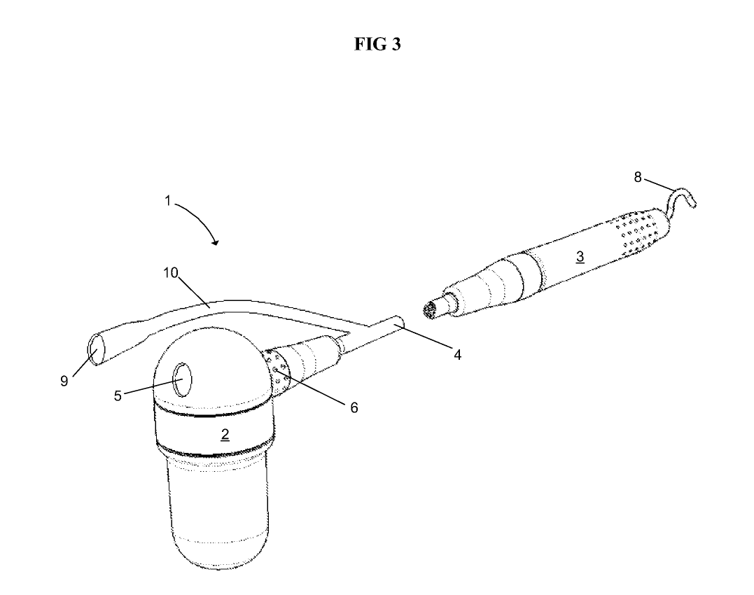

Normally, but not necessarily, pressurized water is also directed towards the treatment area during dental polishing procedures. A flow of pressurized water may be supplied to the polisher device 1 via the same inlet 5 as the pressurized air, in which case the powder chamber comprises two separate fluid channels, one for receiving the pressurized air and one for receiving the pressurized water. The air channel inside the powder chamber 2 is then arranged in fluid communication with the abrasive powder to provide the mixture of air and powder to the hand-held instrument 3, while the water channel is not. The water may alternatively be provided via a second inlet 9 of the powder chamber 2, as shown in FIG. 2, or a second inlet 9 of a hose 10 bypassing the powder chamber 2, as shown in FIG. 3.

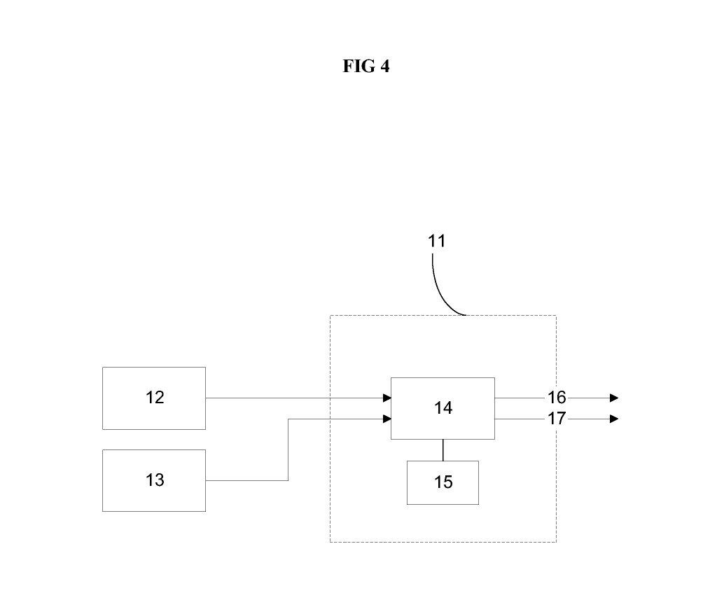

FIG. 4 shows a schematic block diagram of an operational unit 11 that is known in the art and typically realized in form of a dental unit (the dental chair and the standard devices connected thereto or integrated therein) or a stand-alone table-top device. The operational unit 11 serves to provide controlled flows of air and/or water to different dental instruments, such as drills, scalers etc. The operational unit 11 is connected to a pressurized air source 12 and additionally a pressurized water source 13. The delivery of air and water is controlled by a fluid control circuitry 14 regulated by an operator input device 15. The operational unit 11 comprises one or more outlets 16, 17 for connection to different dental instruments. The pressurized air source 12 and the pressurized water source 13 may be integrated in the operational unit 11 but normally the pressurized air and water are delivered to the operational unit 11 by a central delivery system existing in a dentist surgery. The operator input device 15 may be any fluid regulator known in the art, e.g., a rotary control knob attached to the outer surface of the operational unit 11, or a foot-controlled regulator intended to rest on the floor in the dental surgery, connected to the operational unit 11 through an electric cable or a wireless communication interface. The dental polisher device 1 according to the present invention can be adapted to be connected to an outlet 16, 17 of any such existing operational unit 11.

By connecting the polisher device 1 to an outlet of an already existing dental unit or table-top device, the present invention provides the dental professional with a dental polishing device without the need for buying a separate table-top polishing device or without the need for replacing or adjusting the existing dental unit. Furthermore, since the powder chamber 2 of the polisher device 1 is connected external to the operational unit 11, no powder will leak into the components of the fluid control circuitry 14 and no clogging will appear inside the dental unit or the table-top device, thus eliminating the need for frequent cleaning of the table-top device, the dental unit, and the components forming a part thereof.

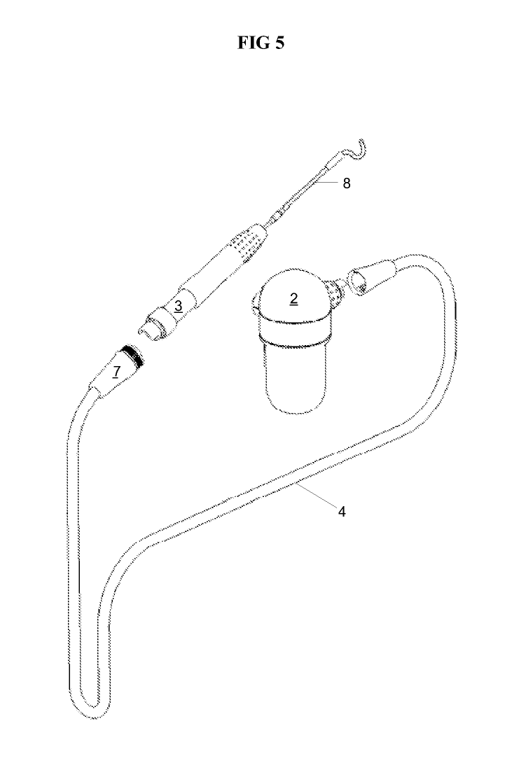

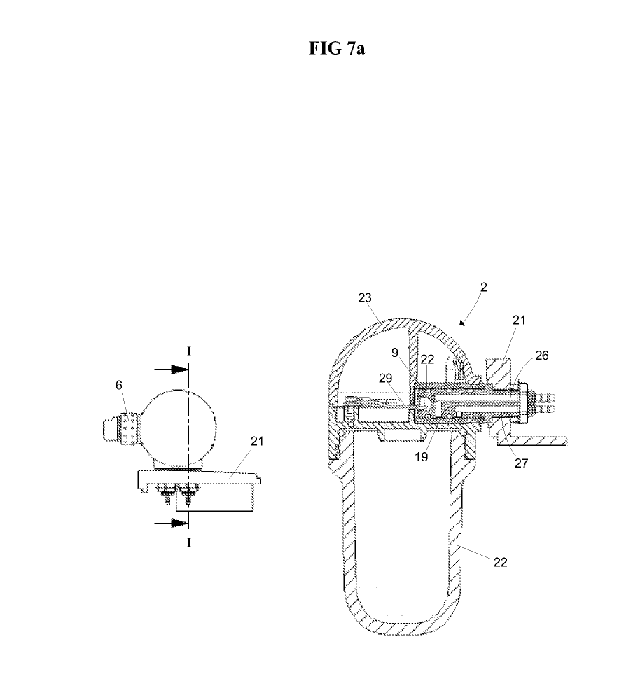

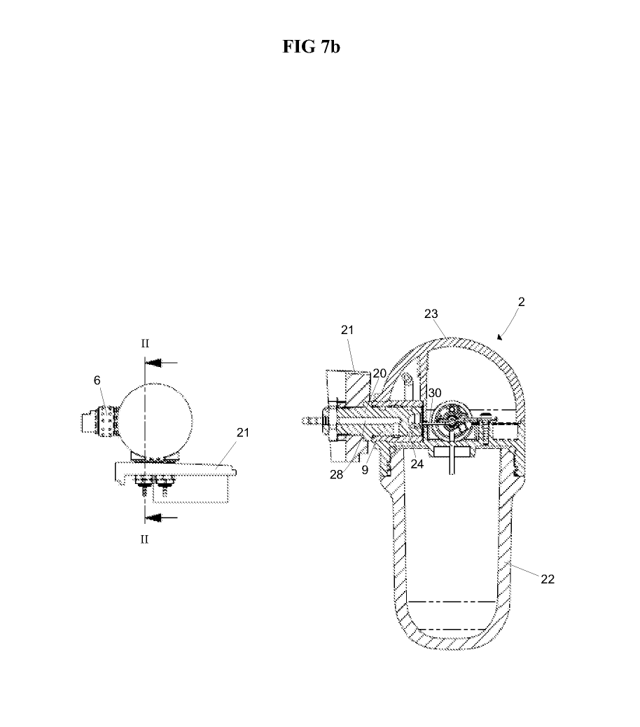

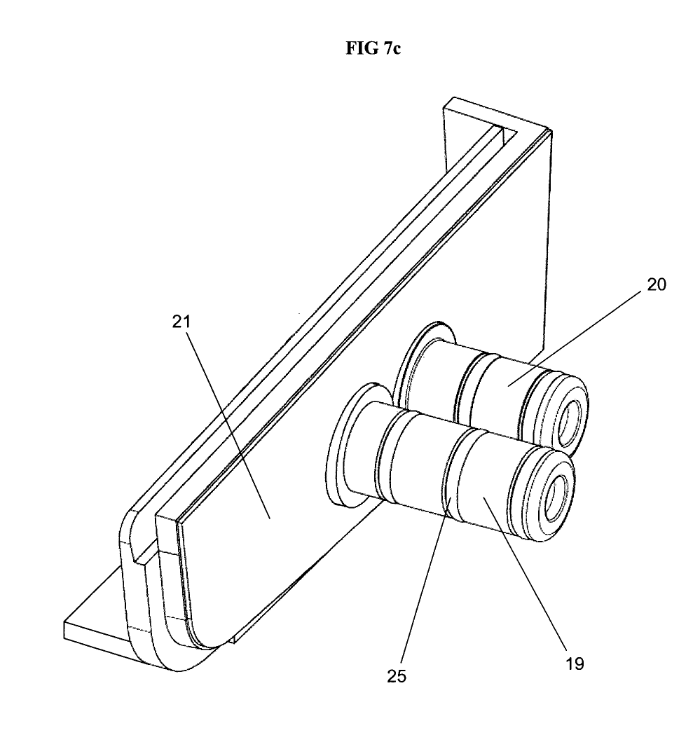

Of course, clogging may still occur inside the powder chamber 2, the hose 4, the handpiece 3, and the nozzle 8 of the polisher device 1. Therefore, as shown in FIG. 5, these components are detachably connected to each other, making the polisher device 1 easy to disassemble into parts that can be separately cleaned and autoclaved. As will be seen in FIGS. 7a and 7b, the powder chamber 2 is composed of two main bodies which are also detachably connected to each other. Hence, the powder chamber 2 is also easily cleaned.

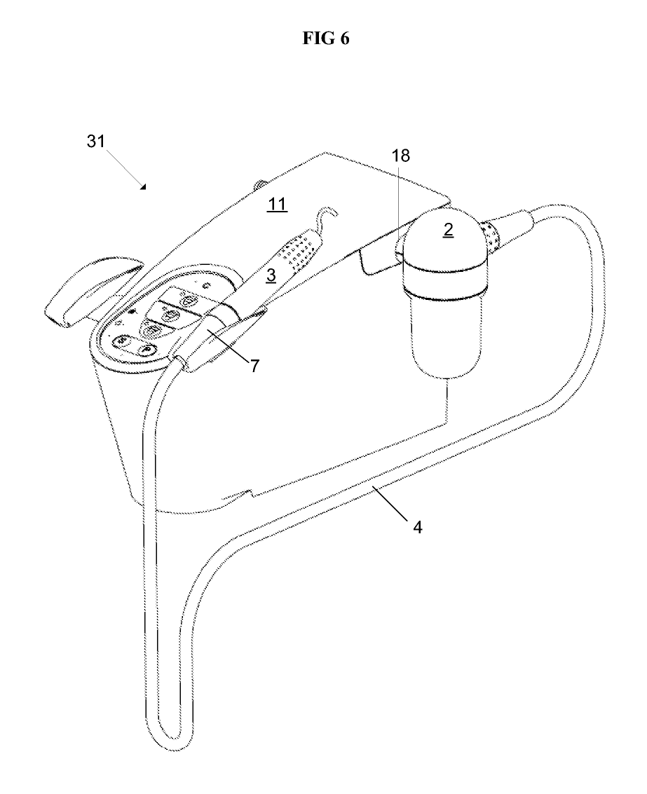

The connections between the components shown in FIG. 6, e.g. the connection between the outlet 6 of powder chamber 2 and the hose 4, may be any type of connection known in the art. The connection means of the outlet 6 may thus be adapted to suit any given connection interface used by different hose providers.

FIG. 6 shows an operational unit 11 realized as a table-top device 11, connected to a polishing device 1 according to the embodiment shown in FIG. 2. Thus, the table top device 11 and the polishing device 1 constitute a table-top polishing apparatus 31. By connecting the powder chamber 2 directly to the table-top device 11 in the illustrated manner, there is no need for intermediate hoses or conduits, thus minimizing the size and the number of components of the table-top polishing device. However, the powder chamber 2 might as well be connected to the operational unit through one or several intermediate hoses and be fixedly connected to something else, such as an instrument board of a dental unit. In that way, a table-top device to which the dental polishing device 2 is connected can be disposed at a distance from the dental unit, the dental professional, and the patient, in a less cramped space, while the powder chamber 2 still can be placed close to the dental professional for easy and fast replenishment thereof during dental proceedings. In such a case, the powder chamber 2 may comprise connection means if form of a suspension arrangement for suspending the powder chamber 2 in a convenient place, or a clip arrangement for clamping the powder chamber 2 to an object in the vicinity of the dental professional.

The table-top device 11 is connected to pressurized air 12 and water 13 sources and comprises a fluid control circuitry 14 and an operator input device 15, as shown in FIG. 4, for supplying a controlled flow of pressurized air and water to the hand-held dental instrument 3 connected to the handpiece connector 7. The powder chamber 2 of the polishing device 1 is connected to the table-top device 11 through connection means 18. The connection means 18 connects the inlets 5, 9 of the polishing device 1 shown in FIG. 2 with the outlets 16, 17 of the operational unit 11 shown in FIG. 4, i.e. the outlets of the table-top device 11. As aforementioned, although the operational unit 11 is realized as a table-top device 11 in FIG. 6, it may as well be realized as a dental unit, connected to the polishing device 1 in the same way.

In FIGS. 7a and 7b, the connection means 18 for establishing a detachable connection between the polishing device 1 and an operational unit 11, such as the table-top device 31 illustrated in FIG. 6, is shown in more detail. A detailed view of the powder chamber 2 according to a preferred embodiment of the invention is also shown. The left-hand pictures illustrate the connection means 18 and the powder chamber 2, as seen from above, while the right-hand pictures illustrate cross sections of the same, taken along the lines I and II, respectively.

Referring now to both FIGS. 7a and 7b, the outlets 16, 17 of the operational unit 11 are provided with male connectors 19, 20, protruding from a portion 21 of the operational unit 11. The powder chamber 2 comprises a container portion 22 for holding abrasive powder, the container portion 22 being detachably connected to a lid portion 23, comprising two inlets 5, 9 arranged to constitute female connectors for detachable connection to the male connectors 19, 20. The male connectors 19, 20 are arranged in fluid communication with a pressurized air source 12 and a pressurized water source 13, respectively, for providing pressurized air and water to the inlets 5, 9 of the powder chamber 2. Preferably, the male connectors 19, 20 are also arranged to provide electric signals from the operational unit 11 to the polisher device 1. This can be achieved by, for example, forming the male connectors 19, 20 at least partially of a conducting material and control a voltage difference applied thereto in order to generate an electric current that can be provided to a hand-held instrument 3 connected to the handpiece connector 7 via cables inside the powder chamber 2 and the hose 4. Preferably, the male connectors 19, 20 and the inlets 5, 9 comprise fastening means providing a strong and stable connection there between. For example, the inlets 5, 9 of the powder chamber 2 may comprise rejections 24 adapted to fit tight into grooves 25 arranged in the male connectors 19, 20. The male connectors 19, 20 comprising such grooves 25 are separately shown in FIG. 7c.

With reference made to FIG. 7a, pressurized air enters the powder chamber 2 via two air channels 26, 27 in the male connector 19. The female connector 9 comprises two openings which are brought into fluid communication with the air channels 26, 27 when the male connector 19 and the female connector 5 are engaged. The openings form the starting point of two separate air channels inside the powder chamber 2, of which one channel is arranged in fluid communication with the container portion 22 for providing a mix of pressurized air and abrasive powder to a handpiece (not shown) connected to the powder chamber through a hose attached to the outlet 6, and the other channel is arranged to bypass the container portion 22 for providing pure air to the handpiece in case a pure blowing operation is desired by the dental professional handling the handpiece. Of course, the male connector 19 can as well comprise a single air channel for providing a single flow of pressurized air to the powder chamber 3 through the female connector 9, in which case the air channel inside the powder chamber 2 arranged to be brought into fluid communication with the single air channel in the male connector 19 can comprise ramifications in case a plurality of air flows are desired. With reference made to FIG. 7b, pressurized water enters the powder chamber 2 through a water channel 28 in substantially the same way. The water channel inside powder chamber 2 that are arranged to be brought into fluid communication with the water channel 28 of the male connector 20 is, of course, arranged to bypass the container portion 22 and provide the pressurized water to a handpiece via the outlet 6. Referring now to both FIGS. 7a and 7b, two electric cables 29, 30 are arranged within the powder chamber 2 to provide electric signals from the male connectors 19, 20 to the outlet 6 to which a hose comprising electric cables is attached to provide the electric signals to a hand-held instrument connected to a handpiece connector at the other end of the hose. Preferably, the current through the electric cables 29, 30 are controlled by controlling the voltage applied to the male connector 19 and 20, respectively. By allowing current to be provided to a hand-held dental instrument connected to the powder chamber 2, electric components comprised within the hand-held instrument may be energized. For example, the current provided by the male connectors 19, 20 can be utilized to energize a lamp integrated into such a hand-held instrument to increase visibility during polishing procedures. Preferably, such a lamp comprises a plurality of LED diodes to assure long lifetime and further increased visibility. Of course, the current provided by the male connectors 19, 20 may also be used to energize other electric components comprised within a handpiece, and provide for operation of electrically operated nozzles connected to the handpiece.

Although a preferred connection interface between the polishing device 1 and an operational unit 11 has been described above with reference made to FIG. 7a-7c, it should be noted that the present invention is not limited to any particular connection interface between the polishing device 1 and an operational unit 11. Different dental units and table-top devices on the dental market have different connection interfaces for connecting dental instruments thereto, and the inlets 5, 9 of the polishing device 1 shown in FIG. 1-3 may be provided with connection means adapted to suit the connection interface used by different dental unit manufactures and table-top device manufacturers. For example, the inlets 5, 9 may be provided with male connectors for connection to outlets 16, 17 of an operational unit 11 arranged as female connectors. In that way, the operational unit does not have to be provided with any protruding portions. The way of conveying air, water, and electric signals from the operational unit 11 to the powder chamber 2 through connection means comprising at least one male and female connector, as described with reference to FIG. 7a-7b, is applicable also to an embodiment wherein the powder chamber 2 comprises the male connector, or male connectors, and the operational unit 11 comprises the female connector, or the female connectors. Moreover, the inlets 5, 9 of the powder chamber 2 do not have to provide for the connection to the operational unit 11. That is, the powder chamber 2 may comprise inlets 5, 9 for receiving flows of pressurized air and water from the operational unit 11, and further comprise separate connection means for establishing the fixed but detachable connection to the operational unit 11. In that case, electric signals from the operational unit 11 may be provided to the powder chamber 2 through the connection means instead of through the inlets 5, 9.

Furthermore, although the embodiment of the polishing device 1 shown in FIG. 2 has been used while describing a preferred connection interface between the polishing device 1 and an operational unit 31, this should not be construed as a limitation of the invention. The male-female connection interface disclosed above may also be used for connecting the embodiment of the polishing device shown in FIG. 1 to an operational unit, in which case all channels 26, 27, 28 for providing pressurized air and water to the polishing device are included in a single male connector. In this case, the polishing device 1 can still be arranged to provide electric signals from an operational unit to a hand-held instrument connected to the polishing device. This can be achieved by, for example, applying different voltages to two separated, conducting pins arranged to protrude from the front portion of the single male connector of the operational unit, and provide the rear-end of the single inlet of the powder chamber with two receiver contacts which, when the powder chamber is connected to the operational unit, are brought into contact with the conducting pins of the male connector. Electric cables may then be arranged to conduct the current from the receiver contacts through the powder chamber 2 and onto the hand-held instrument, through the hose and the handpiece connector. If the present invention is realized in form of the embodiment shown in FIG. 3, the electric signals may, of course, also be provided to a hand-held instrument connected thereto through insulated electric cables disposed in the separate hose 10, bypassing the powder chamber 2.

While the powder chamber 2 has been described in detail with respect to the particular embodiment shown in FIGS. 7a and 7b, those skilled in the art will recognize that other designs of the powder chamber 2 are possible without departing from the inventive concept of the present invention. For example, the shape of the powder chamber 2 may be different, and the inlets 5, 9 and the outlet 6 of the powder chamber 2 may be disposed elsewhere. In another exemplary embodiment of the invention, the powder chamber 3 shown in FIGS. 7a and 7b is “vertically flipped” and the (previous) bottom of the powder container 43 is provided with a lid. This powder chamber design facilitates replenishment of the powder container during polishing procedures and even makes it possible for the dental professional to refill the powder container with a one-hand maneuver while holding a dental instrument with the other hand.

For the sake of simplicity, the polisher device 1 has herein been described with reference to a hose 4, a handpiece connector 7, and a hand-held polishing instrument 3. However, these components are well known in the art and do not necessarily form a part of the present invention. Thus, it is to be understood that the detailed disclosure of the invention only is illustrative and exemplary and merely serves the purpose of providing a full and enabling disclosure thereof. Accordingly, it is intended that the invention should be limited only by the scope of the claims appended hereinafter.

1. A dental polishing device (1) comprising a powder chamber (2) for holding abrasive powder, said powder chamber (2) comprising an inlet (5) and an outlet (6) arranged to be brought in fluid communication with an operational unit (11) for controlling a supply of pressurized air through the powder chamber (2) to a hand-held dental instrument (3) connectable to the outlet (6) of the powder chamber (2) through a hose (4),
characterized in that the powder chamber (2) comprises connection means and is arranged to be fixedly but detachably connected external to the operational unit (11) through said connection means.

2. A dental polishing device (1) according to claim 1, wherein the inlet (5) is arranged to constitute said connection means.

3. A dental polishing device (1) according to claim 1 or 2, wherein the powder chamber (2) comprises a first and a second fluid channel for receiving pressurized air and pressurized water, respectively, from the operational unit (11), said first channel being arranged to provide a mixture of pressurized air and abrasive powder to a hand-held dental instrument (3) connected to the outlet (6) of the powder chamber (2) through a hose (4), while said second channel is arranged to provide pressurized water to the hand-held instrument (3).

4. A dental polishing device (1) according to any of the preceding claims, wherein the powder chamber (2) further comprises means for receiving electric signals from the operational unit (11) and provide the electric signals to a hand-held dental instrument (3) connected to the outlet (6) of the powder chamber (2) through a hose (4).

5. A dental polishing device (1) according to any of the preceding claims, wherein the powder chamber (2) comprises means for separating the received flow of pressurized air into two channels, of which one is brought into fluid communication with the abrasive powder contained therein, while the other is bypassed the abrasive powder in order to provide both a mixed flow of air and abrasive powder, and a flow of pure air, to a hand-held dental instrument (3) connected to the outlet (6) of the powder chamber (2) through a hose (4).

6. A dental polishing device (1) according to any of the preceding claims, further comprising a hose (4), of which one end is detachably connected to the outlet (6) of the powder chamber (2), a handpiece connector (7) connected to the other end of the hose (4), and a hand-held polishing instrument (3) detachably connected to the handpiece connector (7).

7. A dental polishing device (1) according to any of the preceding claims, wherein the connection means of the powder chamber (2) is directly connected to a connector of the operational unit (11).

8. A dental polishing device (1) according to any of the preceding claims, wherein the inlet (5) of the powder chamber (2) is arranged to constitute a female connector (5) adapted to receive a male connector (19, 20) protruding from the operational unit (11), the female connector (5) comprising at least one opening arranged to be brought in fluid communication with an air channel inside said male connector (19, 20) when the female connector (5) is engaged to the male connector (9).

9. A dental polishing device (1) according to claim 7, wherein the female connector (5) further comprises an opening arranged to be brought in fluid communication with a water channel inside said male connector (19, 20) when the female connector (5) is engaged to the male connector (9).

10. A dental polishing device (1) according to claim 7 or 8, wherein the female connector (5) further comprises two receiver contacts arranged to be brought into electric coupling with two conducting elements of a male connector (19, 20) when the female connector (5) is engaged to the male connector (9), said receiver contacts being connected to electric cables for providing a current generated by a voltage difference between the conducting elements of the male connector (19, 20) to a hand-held dental instrument (3) connected to the outlet (6) of the powder chamber (2) through a hose (4).

11. A dental polishing device (1) according to any of the preceding claims, wherein the powder chamber (2) further comprises a second inlet (9), both the first inlet (5) and the second inlet (9) are arranged to constitute female connectors (5, 9), each adapted to receive a male connector (19, 20) protruding from the operational unit (11), one female connector (5) comprises at least one opening arranged to be brought in fluid communication with an air channel inside one of the male connectors (19), and the other female connector (9) comprises at least one opening arranged to be brought in fluid communication with a water channel inside the other male connector (20), when the female connectors (5, 9) are engaged to the male connectors (19, 20).

12. A dental polishing device (1) according to claim 11, wherein the female connectors (5, 9) comprise conducting material arranged to be brought in contact with a conducting portion of the male connectors (9, 10) when the female connectors (5, 9) are engaged to the male connectors (19, 20), said conducting material of the female connectors (5, 9) being connected to electric cables for providing a current generated by a voltage difference between the conducting portions of the male connectors (19, 20) to a hand-held dental instrument (3) connected to the outlet (6) of the powder chamber (2) through a hose (4).

13. A dental polishing device (1) according to any of the preceding claims 1 to 7, wherein the inlet (5) of the powder chamber (2) is arranged to constitute a male connector adapted to be connected to a female connector of the operational unit (11), the male connector comprising at least one opening arranged to be brought in fluid communication with an air channel orifice arranged in the female connector, when the male connector is connected to the female connector.

14. A polishing apparatus comprising:
an operational unit (11) comprising fluid control circuitry (14) and an operator input device (15) for controlling a supply of pressurized air from an air source (12) to a dental instrument,
a dental instrument detachably connected external to said operational unit, characterized in that said dental instrument is the polishing device (1) according to any of the claims 1-13.

15. A polishing apparatus according to claim 14, wherein the operational unit (11) is a stand-alone table-top device (11), the polishing apparatus thus constituting a table-top polishing apparatus (31).

16. A polishing apparatus according to claim 14, wherein the operational unit (11) is a dental unit comprising at least a dental chair, the polishing apparatus thus constituting an integrated polishing apparatus.
